(19) United States
(12) Patent Application Publication
(10) Pub. No.: US 2024/0351056 A1
(43) Pub. Date: Oct. 24, 2024

(54) IMPROVED VALVE ACTUATING MECHANISM ASSEMBLY

(71) Applicant: Wagner Spray Tech Corporation, Plymouth, MN (US)

(72) Inventor: Brian Lee Fideler, Jordan, MN (US)

(21) Appl. No.: 18/639,460

(22) Filed: Apr. 18, 2024

Related U.S. Application Data
(60) Provisional application No. 63/497,776, filed on Apr. 24, 2023.

(51) Int. Cl. B05B 12/00; B05B 9/04

(52) U.S. Cl. CPC B05B 12/002; B05B 9/0426

(57) ABSTRACT

A fluid spray gun include a pressure vessel, a valve disposed in the pressure vessel and configured to be actuated between an open position and a closed position, a trigger actuatable to actuate the valve between the open and closed positions; and a valve actuating mechanism assembly partially disposed in the pressure vessel and coupled to the trigger. The valve actuating mechanism assembly includes an axle, a valve contacting member disposed along the axle and configured to contact the valve, a first sealing element disposed in the pressure vessel and configured to create a first seal against the axle and a first seal against the pressure vessel, a second sealing element disposed in the pressure vessel and configured to create a second seal against the axle and a second seal against the pressure vessel, and a fastener including threads and a hole configured to receive a portion of the axle.

### CROSS-REFERENCE TO RELATED APPLICATION

The present application is based on and claims the benefit of U.S. provisional patent application Ser. No. 63/497,776 filed Apr. 24, 2023, the contents of which is hereby incorporated by reference in their entirety.

### BACKGROUND

Fluid spray guns are typically used in a variety of applications to apply fluid, such as paint, to a surface. Fluid spray guns can include a spray tip that is used to break up, or atomize, a liquid material for delivery in a desired spray pattern. Fluid spray guns can further include a trigger and a valve, actuatable by the trigger, to control the flow of fluid to the spray tip.

While examples described herein are in the context of applying fluid, in the form of paint, to a surface, it is understood that the concepts are not limited to these particular applications and that fluid spray guns, such as those described herein, are operable to apply a variety of fluids. As used herein, paint includes substances composed of coloring matter, or pigments, suspended in a liquid medium as well as substances that are free of coloring matter or pigment. Paint may also include preparatory coatings, such as primers, and can be opaque, transparent, or semi-transparent. Some particular examples include, but are not limited to, latex paint, oil-based paint, stain, lacquers, varnishes, inks, etc.

The discussion above is merely provided for general background information and is not intended to be used as an aid in determining the scope of the claimed subject matter.

### SUMMARY

A fluid spray gun include a pressure vessel, a valve disposed in the pressure vessel and configured to be actuated between an open position and a closed position, a trigger actuatable to actuate the valve between the open and closed positions; and a valve actuating mechanism assembly partially disposed in the pressure vessel and coupled to the trigger. The valve actuating mechanism assembly includes an axle, a valve contacting member disposed along the axle and configured to contact the valve, a first sealing element disposed in the pressure vessel and configured to create a first seal against the axle and a first seal against the pressure vessel, a second sealing element disposed in the pressure vessel and configured to create a second seal against the axle and a second seal against the pressure vessel, and a fastener including threads and a hole configured to receive a portion of the axle.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to examples that solve any or all disadvantages noted in the background.

### BRIEF DESCRIPTION OF THE DRAWINGS

FIG. 1 is a perspective view showing one example fluid application system.

FIG. 2 is a side view showing one example fluid applicator.

FIG. 3 is an exploded view showing one example fluid applicator.

FIG. 4 is a sectional view showing one example pressure vessel.

FIG. 5 is a sectional view showing one example fluid applicator.

FIG. 6 is an exploded view showing one example of a known fluid applicator having one example of a known valve actuating mechanism assembly.

FIG. 7 is an exploded view showing one example valve actuating mechanism assembly.

FIG. 8 is an exploded sectional view showing one example valve actuating mechanism assembly.

FIG. 9 is a sectional view showing one example valve actuating mechanism assembly.

FIG. 10 is a sectional view showing one example valve actuating mechanism assembly.

FIG. 11 is a sectional view showing one example valve actuating mechanism assembly.

FIG. 12 is a perspective view showing one example fastener.

### DETAILED DESCRIPTION OF THE DRAWINGS

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, steps, or a combination thereof described with respect to one example may be combined with the features, components, steps, or a combination thereof described with respect to other examples of the present disclosure.

In a fluid application system, a pump receives and pressurizes a fluid, delivers the pressurized fluid to a fluid applicator, such as a fluid spray gun, which, in turn, applies the pressurized fluid to a surface using a spray tip having a geometry selected to emit a desired spray pattern (e.g., a round pattern, a flat pattern, or a fan pattern, etc.). The fluid may comprise any fluid applied to surfaces, including, but not limited to, for example, paint, primer, lacquers, foams, textured materials, plural components, adhesive components, disinfectants, etc.

In some current fluid application systems, the fluid applicator includes a valve that is actuatable by a trigger to controllably allow and prevent flow of the pressurized fluid to the spray tip. In such systems, the trigger can mount to a valve actuating mechanism which contacts the valve and is moveable, with movement of the trigger, to move the valve between a valve open and a valve closed position (and various positions therebetween). One or more sealing elements have been used in the past to create a seal, such as an O-ring, between the valve actuating mechanism and the applicator to prevent fluid from escaping at the valve actuating mechanism. Further, retaining clips or snap rings have been used to secure the valve actuating mechanism to the applicator and to hold the pressure of the seal between an interior of the fluid applicator and an exterior of the fluid applicator.

Provided herein are example valve actuating mechanism assemblies (also referred to herein as cam assemblies) that include more robust, pressure-assisted sealing elements. Additionally, one or more of the example valve actuating mechanism assemblies provided herein provide for more robust retaining mechanisms for securing the valve actuating mechanism assemblies to the applicator and for holding the pressure of the seal between an interior of the fluid applicator and the exterior of the fluid applicator. One or more of the retaining mechanisms can include keying features to provide tamper proofing.

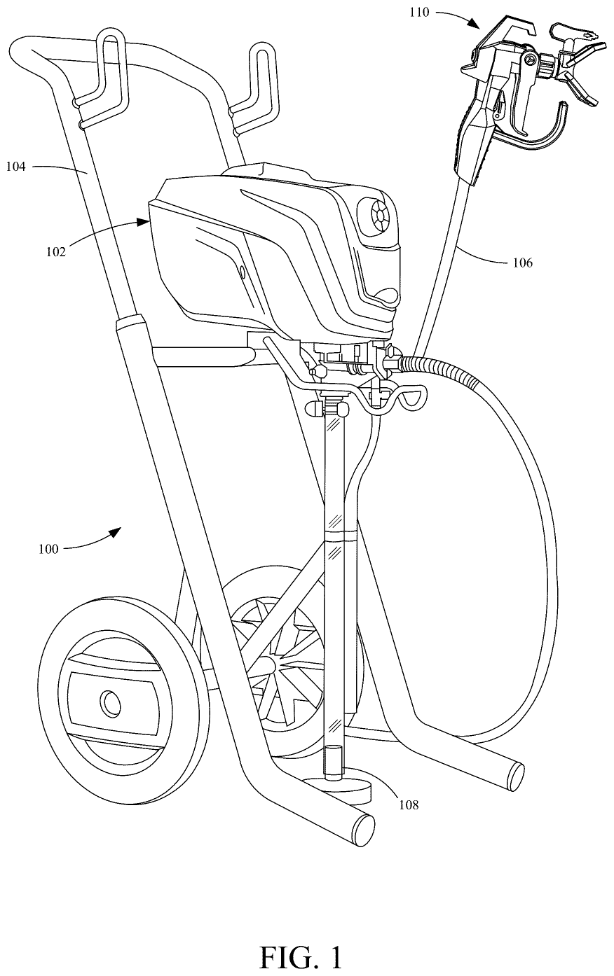

FIG. 1 is a perspective view showing one example fluid applicator system 100. Fluid applicator system 100, illustratively shown as an airless fluid spraying system, includes pump 102, mounted on a cart 104, and couples to and provides pressured fluid to fluid applicator 110 (also referred to herein as applicator 110) through fluid delivery line 106 (shown as a flexible hose). Pump 102 includes a fluid intake 108 that is disposed within a fluid source (e.g., a five-gallon bucket of paint). Pump 102 pumps the fluid from the fluid source through fluid intake 108 and pumps the fluid at a given pressure to applicator 110 through fluid delivery line 106. In one example, pump 102 can pressurize the fluid above 1500 PSI, such as between 1500-3500 PSI.

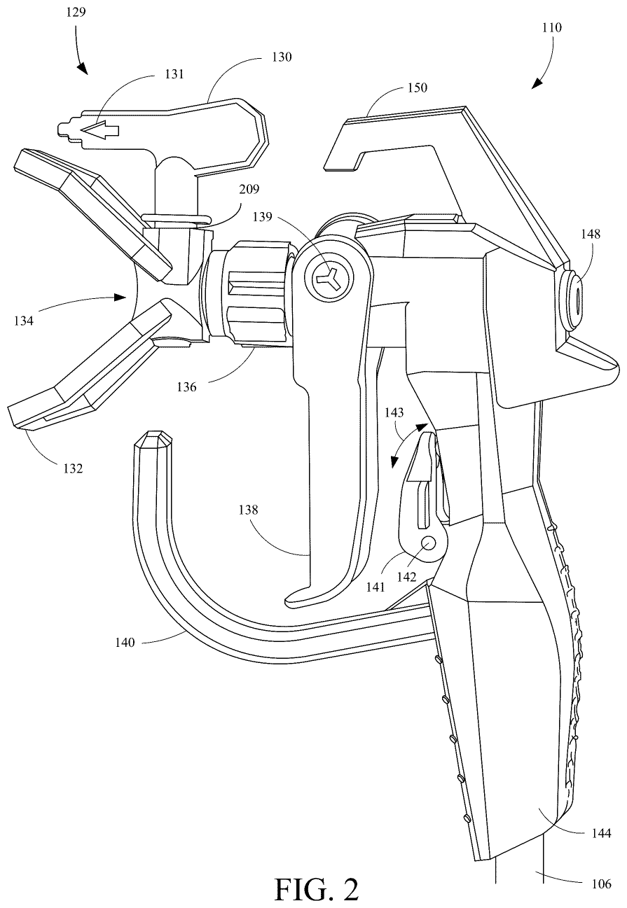

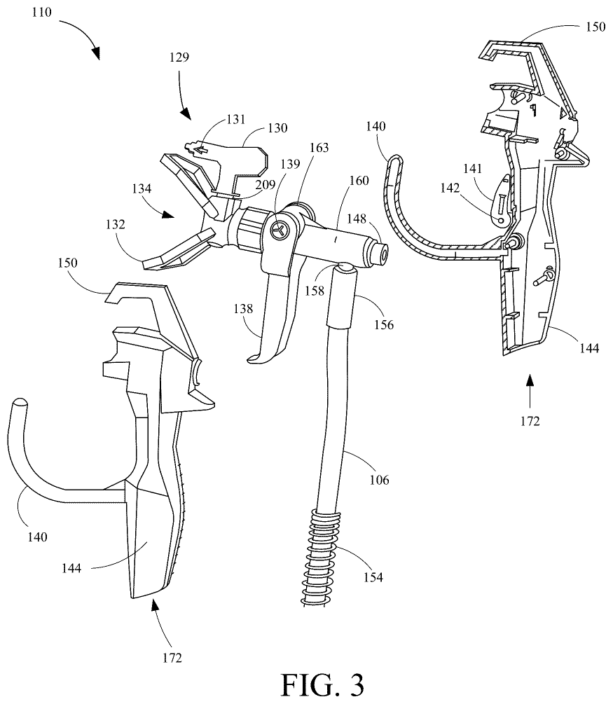

FIG. 2 is a perspective view showing one example fluid applicator 110. Applicator 110, illustratively shown as a spray gun, includes tip 129, outlet guard 132, outlet 134, attachment mechanism 136, trigger 138, trigger guard 140, trigger lock 141, handle 144, filter 148, and hook 150. Applicator 110 receives fluid through an inlet (shown in FIG. 3), for example, from delivery line 106 and into and through the inlet. As will be shown in more detail below, applicator 110 includes, as part of a pressure vessel, an integrated fluid delivery line fitting to which a fluid delivery line, such as fluid delivery line 106, couples to.

Trigger 138 is pivotally mounted to the valve actuating mechanism (shown below) at pivot point(s) 139, which can include any number of rotatable fastening and/or attachment mechanisms. Trigger 138 is actuatable (e.g., by an operator and/or user) to allow (e.g., by actuating a valve in the valve pressure vessel) fluid flow from the inlet to outlet 134 of tip 129 where the fluid is expelled.

As illustrated in FIG. 2, a trigger guard 140 can be coupled to or otherwise be an integral part of handle 144 and can, for instance, protect trigger 138 from accidental or unintended actuation. Trigger lock 141 can be pivotally mounted to handle 144 at pivot point(s) 142, which can include any number of rotatable fastening and/or attachment mechanisms. Trigger lock 141 is deployable (e.g., by user actuation) between a storage position and a locking position as indicated by arrow 143. As illustrated in FIG. 2, trigger lock 141 is in the storage position which allows actuation (e.g., rearward movement) of trigger 138. On the other hand, in the locking position, trigger lock 141 is moved to a substantially perpendicular position relative to a vertical axis of trigger 138 and/or handle 144 and prevents actuation (e.g., rearward movement) of trigger 138.

Hook 150 can, in one example, serve as a storage mechanism for applicator 110. For instance, a user can hang applicator 110 from or otherwise removably couple to any number of items, such as a hook, nail, screw, rod, etc. which can be a part of cart 104.

Returning to the operation of applicator 110, fluid flows through fluid delivery line 106 which, in the illustrated example, is partially disposed within handle 144 and then into and through an inlet. Through the inlet, the fluid enters the pressure vessel and encounters filter 148 which is partially and rearwardly (relative to outlet 134) disposed in the valve pressure vessel. Filter 148 filters out unwanted contaminants in the fluid before it is applied to the application area. From filter 148, the fluid flows to and past a valve (e.g., needle valve) which is actuatable (by actuation of trigger 138) between a seated (closed) an unseated (opened) position. Fluid then encounters a tip 129 (illustratively shown in FIG. 2 as including a flag 130 and stem tip body 209), which can include a number of internal geometries (e.g., turbulence structures, outlet design, etc.), as well as additional features (as will be discussed in greater detail below), and out of outlet 134 of tip 129 to be applied to the application area.

Tip 129 can be removable and can be replaced with the same or different type of tip. Often, different types of tips can be used for a different type of spray pattern or to accommodate different types of fluid to be applied by applicator 110. Tip 129 is coupled to the valve pressure vessel by attachment mechanism 136. As illustrated in FIG. 2, tip 129 can also include keying mechanism 152 which, as shown, is a keyed protrusion on the front of tip 129. Additionally, tip 129 can include indicator 131, illustratively shown as an arrow, which can indicate the proper alignment and/or installation of tip 129 for applying the pressurized fluid on to a surface.

Additionally, fluid applicator 110 includes an outlet guard 132 which can, in one example, serve to prevent a user from placing a portion of their body (e.g., hand, finger, etc.) proximate outlet 134 and/or from placing outlet 134 proximate a surface or item.

FIG. 3 is an exploded view showing one example fluid applicator 110. FIG. 3 shows the additional components of fluid applicator 110. In addition to the items illustrated in FIG. 2, which are numbered similarly, fluid applicator 110 includes delivery line coil 154, fluid delivery line attachment mechanism 156 (illustratively shown and referred to as crimp ferrule 156), fluid delivery line fitting 158 (illustratively shown and referred to as hose barb 158), pressure vessel 160, support structure(s) 162, mounting mechanism 163, and handle portion halves 172.

As illustrated, applicator 110 can include two handle portion halves 172. Handle portion halves 172 can be hollowed-out halves, as represented, that are configured to be coupled together by coupling mechanisms and fit around components of applicator 110 in a proper alignment.

Fluid delivery line 106 is configured to extend within handle portion halves 172 and couple to hose barb 158. As illustrated, delivery line 106 is secured to hose barb 158 by crimp ferrule 156 such that a portion of delivery line 106 is crimped onto hose barb 158. Hose barb 158 is, in one example, an integrated part of pressure vessel 160 such that delivery line 106 couples directly to pressure vessel 160. In any case, fluid is delivered to an interior of pressure vessel 160 through delivery line 106 and hose barb 158 (which acts as an inlet to the interior of pressure vessel 160). Pressure vessel 160 can include a filter 148 (or a portion thereof), a valve (shown below), as well as other items, as will be discussed further herein. Fluid delivery line 106 can be a flexible hose (such as a hose assembly, including a laminated internal sleeve and woven fabric) that allows a user more freedom of movement when operating applicator 110. Delivery line 106, as illustrated, includes fluid delivery line coil 154 which can help to maintain the flexibility of delivery line 106 while preventing interference with fluid movement through delivery line 106, which can be caused by the operation or storage of applicator 110, for example, but not limited to, kinks, knots, twists, ties, etc. in delivery line 106. Additionally, coil 154 can protect delivery line 106 from damage which can interfere with fluid movement through or otherwise deteriorate deliver line 106, for instance, punctures, dents, etc., by preventing objects from coming into direct contact with delivery line 106.

Pressure vessel 160 can include additional items and features. As shown, pressure vessel 160 includes mounting mechanism 163 which is configured to receive and house portions of a rotatable valve actuating mechanism such that trigger 138 can be pivotably coupled to pressure vessel 160 at pivot point(s) 139. In one example, mounting mechanism 163 has a hole therethrough configured to receive portions of the rotatable valve actuating mechanism. The rotatable valve actuating mechanism can include mating features (e.g., protrusions, male mating features, etc.) on one or both of its respective ends and trigger 138 can have corresponding mating features (e.g., recesses, female mating features, etc.) which receive the mating features of the fastening mechanism (though the male and female mating features can be reversed, e.g., the recesses can be on the rotatable fastening mechanism and the protrusions can be on trigger 138). In one example, this allows the trigger to be “snapped-on.” This is shown in more detail below. The fit between the hole of mounting mechanism 163 and the rotatable valve actuating mechanism can be such that actuating mechanism is securely coupled to fluid applicator 110 but still rotatable within mounting mechanism 163.

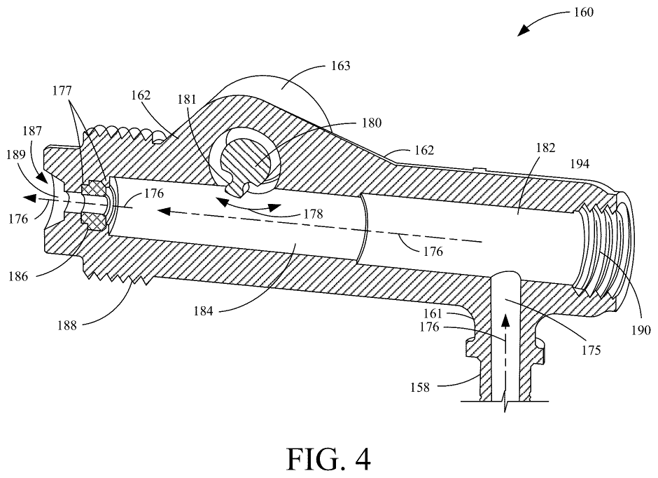

FIG. 4 is a sectional view showing pressure vessel 160 in more detail. FIG. 4 shows the additional components, including internal components, of pressure vessel 160. In addition to the items illustrated in FIG. 3, which are numbered similarly, pressure vessel 160 includes inlet 175, flow path 176, valve actuating mechanism 180, filter chamber 182, valve chamber 184, valve seat 186, pressure vessel outlet 187, and recess 189.

As illustratively shown, pressure vessel 160 is configured to receive pressurized fluid from delivery line 106 through inlet 175, defined by an internal diameter of fluid delivery line fitting (or hose barb) 158. Delivery line 106 can be coupled to hose barb 158 (and thus fluidically coupled to inlet 175) by crimping (e.g., with crimp ferrule 156) a portion of delivery line 106 to hose barb 158.

Pressurized fluid travels along a flow path indicated by arrows 176. The internal components and walls of valve pressure vessel 160 are exposed to the pressurized fluid as it travels through hose barb 158 and inlet 175 through filter chamber 182, valve chamber 184 and valve seat 186 and finally through and out of pressure vessel outlet 187 which can be fluidically coupled to a tip assembly and can, in one example, receive a portion of the tip assembly in recess 189, for instance, a tip saddle (as will be shown later).

The movement of pressurized fluid along the flow path 176 is controlled by the actuation of trigger 138 which is pivotably coupled to valve actuating mechanism 180 (as described above). Valve actuating mechanism 180, also referred to as cam 180, is actuatable between a first (e.g., valve closed) position and a second (e.g., valve open) position (though valve actuating mechanism 180 is actuatable to a number of positions in the intermediate between the fully closed and fully open positions), as indicated by arrow 178. As shown, valve actuating mechanism 180 is in the first position, which corresponds with the position of trigger 138 illustrated in FIG. 2, wherein the valve is closed (e.g., seated against valve seat 186) such that pressurized fluid will not flow out of pressure vessel outlet 187. As shown, actuating mechanism 180 includes a valve contacting member 181, also referred to as cam lobe 181, which contacts and acts against a portion of the valve to open the valve (e.g., unseat the valve from valve seat 186) as the trigger is actuated to move the actuating mechanism 180 in an upstream direction (e.g., away from pressure vessel outlet 187).

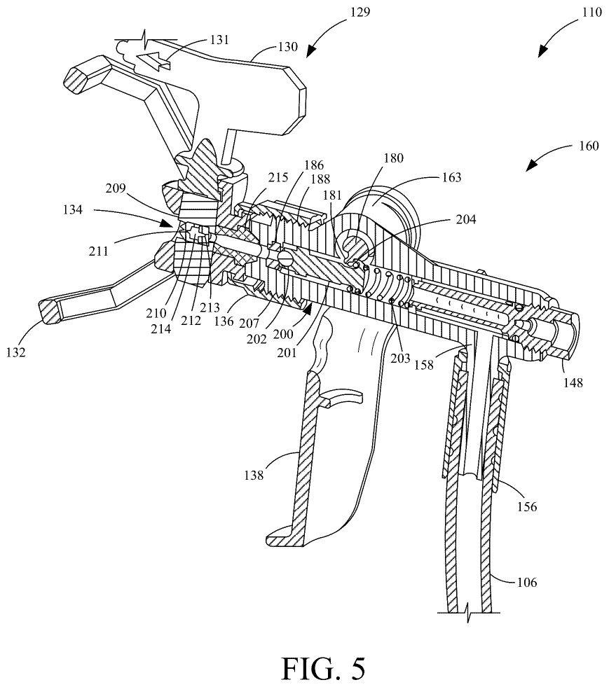

FIG. 5 is a sectional view showing valve fluid applicator 110 in more detail. FIG. 5 shows additional components, including internal components, of fluid applicator 110. In addition to the items illustrated in previous figures, which are numbered similarly, fluid applicator 110 includes valve 200, valve drive stem 201, valve seat stem 202, spring 203, valve shoulder 204, coupling features 205 and 207, tip piece 210, tip piece inlet portion 211, pre-orifice piece 212, pre-orifice piece outlet portion 213, turbulence chamber 214 and tip saddle 215.

From filter 148, the pressurized fluid encounters valve 200. As shown, valve 200 is in a first position (closed) seated against valve seat 186 wherein valve seat stem 202 engages valve seat 186 and creates a sealed interface therebetween such that the pressurized fluid is prevented from exiting valve pressure outlet 187. As discussed previously, trigger 138 is actuatable to rotatably move valve actuating mechanism 180 such that valve contacting member 181 engages valve shoulder 204, disposed on valve drive stem 201, to move valve 200 upstream to a second position (open) unseated from valve seat 186 such that the pressurized fluid can exit valve pressure outlet 187. Spring 203 biases valve 200 towards a closed (or seated) position. Valve 200, when actuated by valve actuating mechanism 180, bears against (and compresses) spring 203. When a user and/or operator releases trigger 138, thus driving movement of valve contacting member 181 away from valve shoulder 204 (or moves valve contacting member 181 downstream), the biasing of spring 203 drives valve 200 back to a closed, or seated, position.

From valve pressure outlet 187, the pressurized fluid encounters a tip assembly which, in addition to the items shown in previous figures, similarly numbered here, includes tip piece 210, pre-orifice piece 212, and tip saddle 215, and can include various other items as well. The tip assembly is coupled to pressure vessel 160 by attachment mechanism 136. Tip saddle 215 is sealingly seated within recess 189 of pressure vessel 160 and includes a fluid pathway through tip saddle 215 to pre-orifice piece 212.

Pre-orifice piece 212 is disposed within tip body 209 and includes a pre-orifice outlet 213. As shown, pre-orifice outlet 213 comprises an increasing diameter in the upstream to downstream direction but can include any number of dimensional diameters. Pre-orifice outlet 213 is sealingly engaged with tip piece 210 within tip body 209 to form turbulence chamber 214. Turbulence chamber 214 includes dimensionality (e.g., diameters) and structures (e.g., surfaces, shoulders, etc.) which are configured to create turbulence of the pressurized fluid.

From turbulence chamber 214, the pressurized fluid encounters an interior diameter that defines tip piece inlet 211 which comprises a decreasing diameter in the upstream to downstream direction, however, tip piece inlet 211 can include any number of dimensional diameters. Tip piece 210 and tip piece inlet 211 are of a design to effectuate a certain spray pattern, flow rate and/or volume of the pressurized fluid from applicator 110, as well as various other characteristics. From tip piece 210, the pressurized fluid exits fluid applicator 110 out of outlet 134 such that the fluid can be applied to a surface.

It will be noted that in some examples, various components of the fluid applicator 110, including, but not limited to the pressure vessel 160, can comprise (or be formed of) polymer, such as plastic or nylon (such as glass-filled nylon), as well as other polymers. It will be noted that fluid applicators, and their components, can comprise other types of materials such as one or more of a variety of metals.

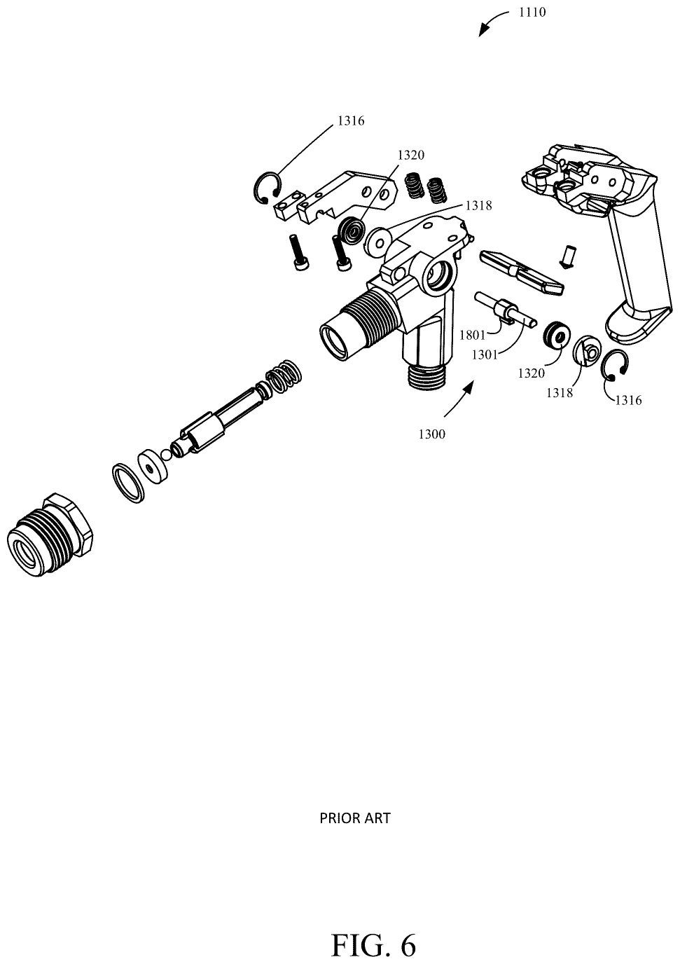

FIG. 6 is an exploded view showing one example known fluid applicator 1110 that includes one example of a known valve actuating mechanism assembly 1300. Valve actuating mechanism assembly 1300 includes valve actuating mechanism 1800, which includes an axle 1301, and valve contacting member 1801. Assembly 1300 further includes seals 1320, bushings 1318, and retainers 1316 (illustratively snap rings).

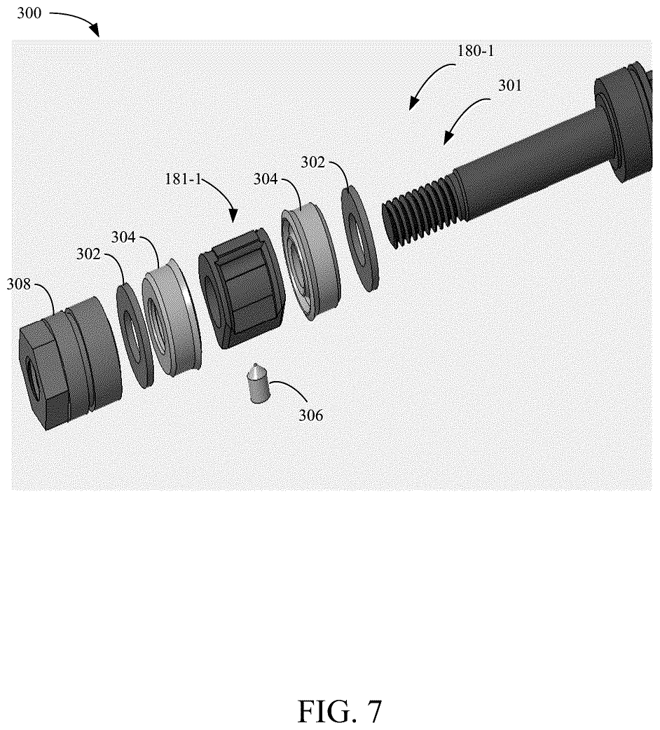

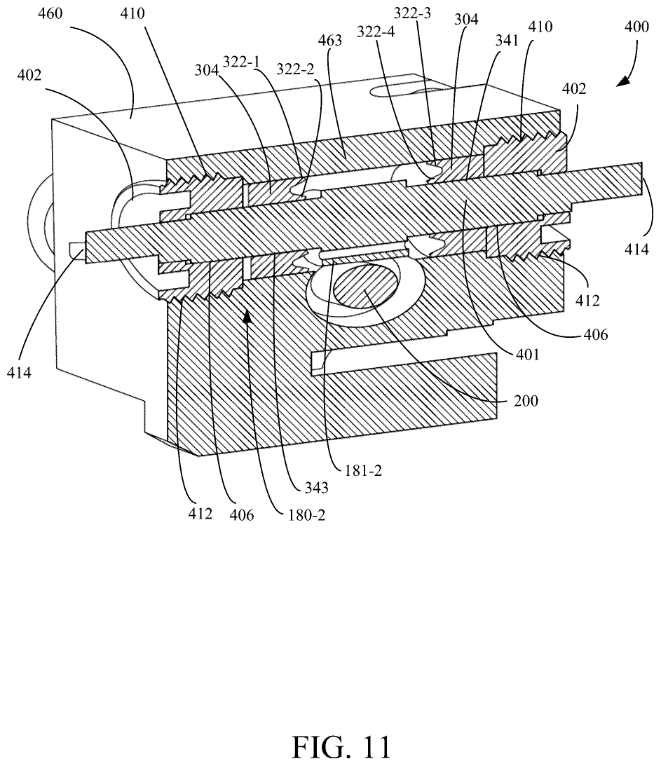

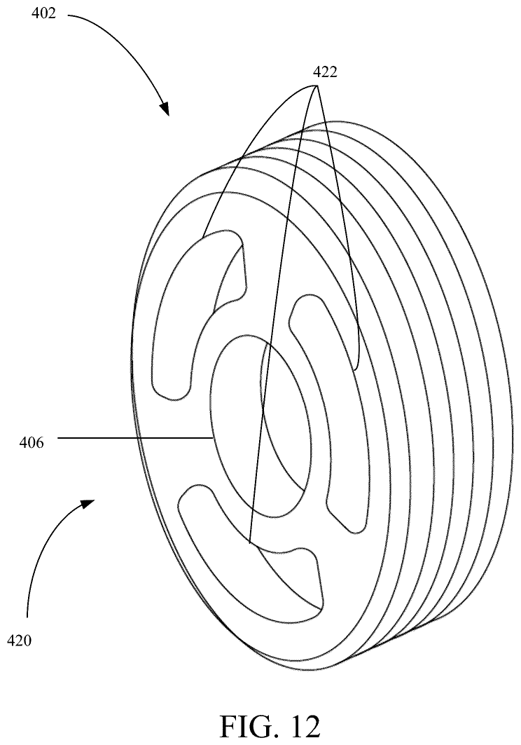

Exemplary embodiments disclosed herein provide improvements over the known example shown in FIG. 6. For example, in the exemplary embodiments shown in FIGS. 7-10, the axle (301) itself holds the pressure of the seal, by virtue of the coupling (e.g., threaded coupling) between the axle and the fastener (308), which is more resilient than the known example shown in FIG. 6 in which the pressure of the seal is held by retainers 1316 (illustratively snap rings). In the exemplary embodiments shown in FIGS. 11-12, the fluid applicator body (body of pressure vessel 160) itself holds the pressure of the seal, by virtue of the coupling (e.g., threaded coupling) between the fluid applicator body and the fasteners (402), which is more resilient than the known example shown in FIG. 6 in which the pressure of the seal is held by retainers 1316, as discussed above.

FIG. 7 shows one example valve actuating mechanism assembly 300. Valve actuating mechanism assembly 300 includes valve actuating mechanism 180-1 (as one example valve actuating mechanism 180) which includes axle 301, valve contacting member 181-1 (as one example valve contacting member 181), set screw 306, and fastener 308. Valve actuating mechanism assembly 300 further includes washers 302 and scaling elements 304.

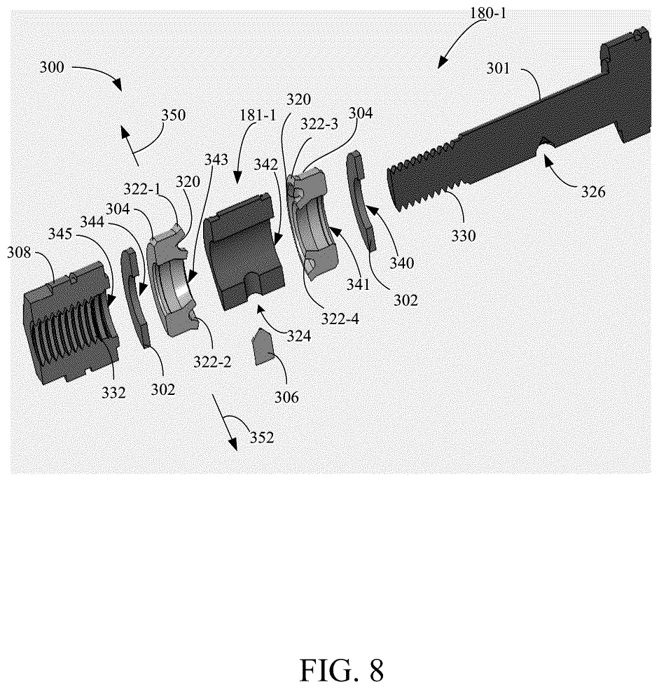

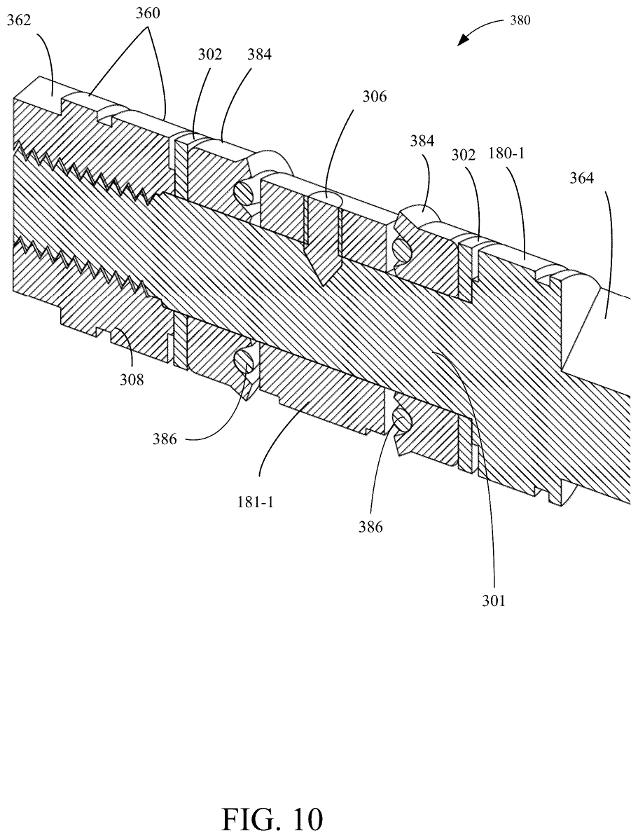

FIG. 8 is a sectional view showing valve actuating mechanism assembly 300 in more detail. As illustrated in FIG. 7, scaling elements 304 are cup seals (sometimes also referred to as U-cup seals) that each include an annular groove 320 that defines two lips 322. Sealing elements 304 are pressure-assisted sealing elements, that is, sealing elements 304 create pressure-assisted seals. When exposed to pressure, sealing elements 304 compress and each lip 322 is moved in a respective direction to more firmly establish the respective seal of each lip 322. As pressure increases, the lips 322 are moved further in their respective directions to more firmly establish the seals. As shown each of upper lip 322-1 and upper lip 322-3 is moved in the direction indicated by arrow 350 and each of lower lip 322-2 and 322-4 is moved in the direction indicated by arrow 352. In some example embodiments, sealing elements 304 can further include an energizer (such an example is shown in FIG. 10). Further, as can be seen in FIG. 8, valve contacting member 181-1 includes a channel 324 through which set screw 306 travels to be secured within a recess 326 of axle 301 to removably couple valve contacting member 181-1 to axle 301. As can further be seen in FIG. 8, axle 301 includes a coupling feature 330 (illustratively shown as threads) that are configured to mate with a coupling feature 332 (illustratively shown as threads) of fastener 308 (illustratively shown as a nut).

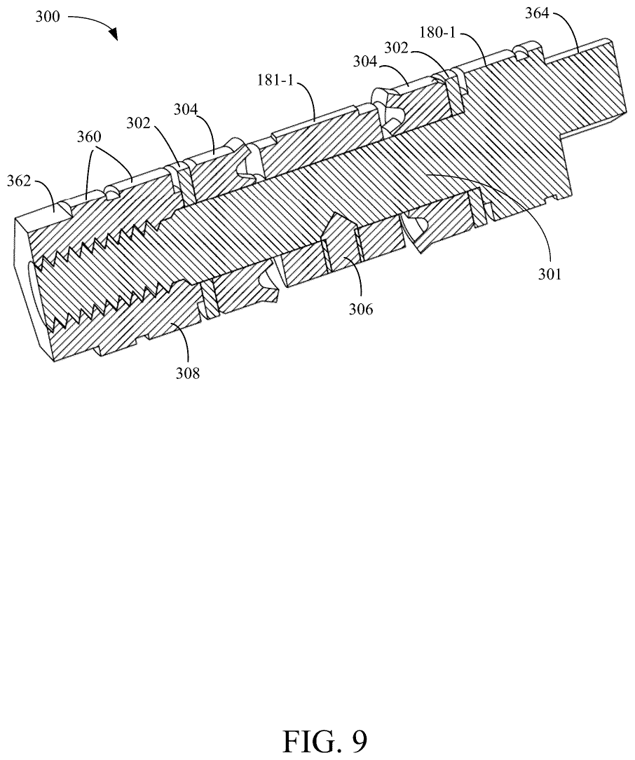

As will be shown in FIG. 9, axle 301 is configured to be provided through a hole 340 (best shown in FIG. 8) of first washer 302, a hole 341 (best shown in FIG. 8) of first scaling element 304, a hole 342 (best shown in FIG. 8) of valve contacting member 181-1, a hole 343 (shown in FIG. 8) of a second sealing element 304, a hole 344 (best shown in FIG. 8) of a second washer 302, and then provided within a hole 345 (best shown in FIG. 8) of fastener 308 whereby coupling feature 330 and coupling feature 332 mate to secure the valve actuating mechanism assembly 300 together.

FIG. 9 is a section view showing valve actuating mechanism assembly 300 in an assembled state. As illustrated in FIG. 9, fastener 308 includes a surface 360 to which one portion of a trigger 138 is mounted. It should be noted that, in one example, the trigger 138 can include a hole through which a portion of fastener 308 is to extend such that trigger 138 can be mounted on surface 360. Advantageously, in such an example, trigger 138 is not configured to mount on the hexagonal portion 362 of fastener 308 as that would require perfect alignment between the corresponding hexagonal hole of the trigger 138 and the hexagonal portion 362 of fastener. In other examples, instead of a hexagonal portion 362, fastener could include a keying mechanism configured to be received by a keying mechanism of the trigger 138. As can further be seen in FIG. 9, an end of axle 301 comprises a keying mechanism 364 that is configured to mate with a corresponding keying mechanism of trigger 138. Thus, trigger 138 is configured to snap on to valve actuating mechanism assembly 300.

As further illustrated in FIG. 9, sealing elements 304 each establish two respective seals, one against a respective portion of valve actuating mechanism 180-1 (e.g., against a respective portion of axle 301) and one against a respective portion of pressure vessel 160 (e.g., a respective portion of mounting mechanism 163). It will be noted that sealing elements 304 do not rotate with valve actuating mechanism 180-1, that is, axle 301 freely rotates within hole 341 and hole 343 of seals 304. Fastener 304 does rotate with axle 301.

FIG. 10 is a section view showing valve actuating mechanism assembly 380 in an assembled state. FIG. 10 is similar to FIGS. 7-9 and thus similar items are numbered similarly. Valve actuating mechanism assembly 380 is similar to valve actuating mechanism assembly 300 except that valve actuating mechanism 380 includes scaling elements 384 instead of sealing elements 304. Scaling elements 384 are similar to sealing elements 304 except that scaling elements 384 each further include an energizer 386. Energizers 386, in the illustrated examples, are O-ring energizers, though other forms of energizers are contemplated herein, such as spring energizers. Each energizer 386 helps to establish and maintain the seals of lips 322. The energizers can comprise various materials, such as metal, rubber, as well as other materials.

FIG. 11 shows one example valve actuating mechanism assembly 400 installed in a pressure vessel 460. Some items in FIG. 10 are similar to items in previous figures and are thus numbered similarly. Valve actuating mechanism assembly 400 includes valve actuating mechanism 180-2 (as one example valve actuating mechanism 180) which includes axle 401, valve contacting member 181-2 (as one example valve contacting member 181), and fasteners 402. Valve actuating mechanism assembly 400, in the example illustrated in FIG. 11, further includes sealing elements 304. In other examples, valve actuating mechanism assembly 400 could include sealing elements 384 instead of sealing elements 304.

In contrast to the valve contacting member 181-1 (which is a separate piece removably coupleable to axle 301 of valve actuating mechanism 180-1), valve contacting member 181-2 is an integral part of valve actuating mechanism 180-2, that is, is integrated with the body of axle 401. For example, axle 401 and valve contacting member 181-2 may be a single molded or cast piece.

As shown, each end of axle 401 is configured to travel through a respective hole (one of 341 or 343) of a respective sealing element 304 (or a hole of a respective sealing element 384 in other examples) and a respective hole 406 of each of a first fastener 402 and a second fastener 402.

Each fastener 402 includes a coupling feature 410 (illustratively shown as threads) which are configured to mate with a respective coupling feature 412 at each of a first end and a second end of pressure vessel 460 (e.g., respective threads of mounting mechanism 463) to securely couple valve actuating mechanism assembly 400 to pressure vessel 460 and to provide further sealing.

As can be seen in FIG. 11, sealing elements 304 (or sealing elements 384 in other examples) each establish two respective seals, one against a respective portion of valve actuating mechanism 180-2 (e.g., against a respective portion of axle 401) and one against a respective portion of pressure vessel 460 (e.g., a respective portion of mounting mechanism 463). It will be noted that sealing elements 304 and fasteners 402 do not rotate with valve actuating mechanism 180-2, axle 301 freely rotates within hole 341 and hole 343 of seals 304 and freely rotates within a respective hole 406 of each fastener 402.

As can further be seen in FIG. 11, each end of valve actuating mechanism 180-2 includes a keying mechanism 414 which is configured to mate with a corresponding keying mechanism of trigger 138. In other examples, only one end of valve actuating mechanism 180-2 includes a keying mechanism while the other end includes a surface, similar to surface 360, or another type of non-keyed surface.

It will be noted that the, in one example, valve pressure vessel 460 comprises metal.

FIG. 12 is a perspective view showing a fastener 402 in more detail. As shown in FIG. 10, fastener 402 can include a tamper-proofing feature 420 (illustratively shown as a plurality of keyed slots 422) which requires the use of a special tool (e.g., configured to mate with the keyed slots 422) to tighten and loosen the fastener 402. In this way, the assembly and securement of valve actuating mechanism assembly 400 cannot be tampered with by hand or by use of a general tool.

The exemplary embodiments shown in FIGS. 7-10 can be particularly advantageous for use in a fluid applicator having a polymer gun body (e.g., polymer pressure vessel or other gun body that receives the valve actuating mechanism assembly) whereas the exemplary embodiments shown in FIGS. 11-12 can be particularly advantageous for use in a fluid applicator having a metal gun body (e.g., metal pressure vessel or other gun body that receives the valve actuating mechanism assembly). This is because threaded connection to a gun body (e.g., pressure vessel 460), as shown in the exemplary embodiments in FIGS. 11-12, is less desirable where the gun body comprises polymer as the polymer threads may be less robust than metal threads. The exemplary embodiments in FIGS. 7-10 do not utilize threaded connection to the gun body and thus, may be more suitable for use in a fluid applicator having a polymer gun body.

Although the present invention has been described with reference to preferred examples, workers skilled in the art will recognize that changes may be made in form and detail without departing from the spirit and scope of the invention.

Additionally, while a particular order of steps has been described for the sake of illustration, it is to be understood that some or all of these steps can be performed in any number of orders.

It should also be noted that the different examples described herein can be combined in different way. That is, parts of one or more examples can be combined with parts of one or more other examples. All of this is contemplated herein.

What is claimed is:

1. A fluid spray gun comprising:
a pressure vessel;
a valve disposed in the pressure vessel and configured to be actuated between an open position and a closed position;
a trigger actuatable to actuate the valve between the open and closed positions; and
a valve actuating mechanism assembly partially disposed in the pressure vessel and coupled to the trigger, the valve actuating mechanism assembly comprising:
an axle;
a valve contacting member disposed along the axle and configured to contact the valve;
a first sealing element disposed in the pressure vessel and configured to create a first seal against the axle and a first seal against the pressure vessel;
a second sealing element disposed in the pressure vessel and configured to create a second seal against the axle and a second seal against the pressure vessel; and
a fastener including threads and a hole configured to receive a portion of the axle.

2. The fluid spay gun of claim 1, wherein the threads of the fastener are on an interior surface of the fastener and are configured to mate with threads on a first end of the axle.

3. The fluid spray gun of claim 2, wherein the trigger is configured to mount on the fastener.

4. The fluid spray gun of claim 3, wherein the axle comprises a second end, the second end comprising a keying mechanism, and wherein the trigger is configured to mount on the keying mechanism.

5. The fluid spray gun of claim 1, wherein the axle includes an end configured to be disposed through the hole of the fastener and wherein the trigger is configured to mount to the end of the axle.

6. The fluid spray gun of claim 1, wherein the threads of the fastener are on an exterior surface of the fastener and are configured to mate with threads of the pressure vessel.

7. The fluid spray gun of claim 6, wherein the fastener comprises a first fastener including a first hole configured to receive a first portion of the axle and first threads, on an exterior surface of the first fastener, configured to mate with first threads of the pressure vessel, the valve actuating mechanism assembly further comprising:
a second fastener including a second hole configured to receive a second portion of the axle and second threads, on an exterior surface of the second fastener, configured to mate with second threads of the pressure vessel.

8. The fluid spray gun of claim 7, wherein the axle includes a first end configured to be disposed through the first hole of the first fastener and a second end configured to be disposed through the second hole of the second fastener, and wherein the trigger is configured to mount to the first end of the axle and the second end of the axle.

9. A valve actuating mechanism assembly for use in a fluid spray gun, the valve actuating mechanism assembly comprising:
an axle;
a valve contacting member disposed along the axle and configured to contact a valve;
a first sealing element disposed along the axle and configured to create a first seal against the axle and a first seal against a body of the fluid spray gun;
a second sealing element disposed along the axle and configured to create a second seal against the axle and a second seal against the body of the fluid spray gun; and
a fastener including threads and a hole configured to receive a portion of the axle.

10. The valve actuating mechanism assembly of claim 9, wherein the threads of the fastener are on an interior surface of the fastener and are configured to mate with threads on a first end of the axle.

11. The valve actuating mechanism assembly of claim 10, wherein the fastener includes an exterior surface configured to receive a trigger of the fluid spray gun.

12. The valve actuating mechanism assembly of claim 11, wherein the axle comprises a second end, the second end comprising a keying mechanism configured to mate with a keying mechanism of the trigger of the fluid spray gun.

13. The valve actuating mechanism assembly of claim 9, wherein the axle includes an end configured to be disposed through the hole of the fastener and to receive a trigger of the fluid spray gun.

14. The valve actuating mechanism assembly of claim 9, wherein the threads of the fastener are on an exterior surface of the fastener and are configured to mate with threads of the body of the fluid spray gun.

15. The valve actuating mechanism assembly of claim 14, wherein the fastener comprises a first fastener including a first hole configured to receive a first portion of the axle and first threads, on an exterior surface of the first fastener, configured to mate with first threads of the body of the fluid spray gun, the valve actuating mechanism assembly further comprising:
a second fastener including a second hole configured to receive a second portion of the axle and second threads, on an exterior surface of the second fastener, configured to mate with second threads of the body of the fluid spray gun.

16. The valve actuating mechanism assembly of claim 15, wherein the axle includes:
a first end configured to be disposed through the first hole of the first fastener and to receive a trigger of the fluid spray gun; and
a second end configured to be disposed through the second hole of the second fastener and to receive the trigger of the fluid spray gun.

17. A fluid spray system comprising:
a pump configured to pressurize fluid;
a fluid spray gun configured to receive the pressurized fluid from the pump, the fluid spray gun comprising:
a spray tip configured to emit the pressurized fluid in a spray pattern;
a pressure vessel;
a valve disposed in the pressure vessel and actuatable to control flow of the pressurized fluid to the spray tip;
a trigger actuatable to actuate the valve; and
a valve actuating mechanism assembly partially disposed in the pressure vessel and coupled to the trigger, the valve actuating mechanism assembly comprising:
an axle;
a valve contacting member disposed along the axle and configured to contact the valve;
a first sealing element disposed in the pressure vessel and along the axle;
a second sealing element disposed in the pressure vessel and along the axle; and
a fastener including threads and a hole configured to receive a first end of the axle.

18. The fluid spay system of claim 17, wherein the threads of the fastener are on an interior surface of the fastener and are configured to mate with threads on the first end of the axle, wherein the axle includes a second end comprising a keying mechanism, and wherein the trigger is configured to mount on the fastener and on the keying mechanism.

19. The fluid spray system of claim 17, wherein the threads of the fastener are on an exterior surface of the fastener and are configured to mate with threads of the pressure vessel.

20. The fluid spray system of claim 19, wherein the fastener comprises a first fastener including a first hole configured to receive the first end of the axle and first threads, on an exterior surface of the first fastener, configured to mate with first threads of the pressure vessel, the valve actuating mechanism assembly further comprising:
a second fastener including a second hole configured to receive a second end of the axle and second threads, on an exterior surface of the second fastener, configured to mate with second threads of the pressure vessel; and
wherein the trigger is configured to mount to the first end of the axle and the second end of the axle.
